(19) United States
(12) Patent Application Publication
(10) Pub. No.: US 2008/0034795 A1
(43) Pub. Date: Feb. 14, 2008

(54) Joining or Sealing Element Made of a Glass-Infiltrated Ceramic or Metal Composite and Method for the Use Thereof

(75) Inventors: Jens Adam, Saarbruecken (DE); Helmut Schmidt, Saarbruecken-Guedingen (DE)

Correspondence Address: GREENBLUM & BERNSTEIN, P.L.C., 1950 ROLAND CLARKE PLACE, RESTON, VA, 20191, US

(73) Assignee: Liebniz-Institut Fuer Neue Materialien Gemeinnuetzige GMBH, Sarrbruecken (DE)

(21) Appl. No.: 11/587,927

(22) PCT Filed: Apr. 29, 2005
(86) PCT No.: PCT/EP05/04662

§ 371 Date: Feb. 7, 2007

(30) Foreign Application Priority Data
Apr. 30, 2004 (DE) 102004021424.7

(51) Int. Cl. C04B 41/50; C04B 41/45

(52) U.S. Cl. 65/36; 501/15

(57) ABSTRACT

A joining or sealing element made of a glass-infiltrated ceramic or metal composite is described. The joining or sealing element serves for joining or sealing at least one component. Furthermore, a method for joining or sealing at least one component with the joining or sealing element and the use of the joining or sealing elements are described.

The present invention relates to a joining or a sealing element made of a glass-infiltrated ceramic or metal composite, a method for the production of the joining or sealing element which is connected to at least one component, and the use of these joining or sealing elements.

The provision of gas-tight joints may be associated with requirements which lead to problems in the realization of suitable joints. Such requirements may include high-temperature stability, gas impermeability even at elevated pressure, corrosion resistance, abrasion resistance, chemical resistance and mechanical strength. Difficulties may also arise as a result of the required geometry, for example in the case of a complex geometry if the space to be bridged is relatively large in relation to the joining areas or if the arrangement of the areas to be joined is already substantially fixed prior to the joining process.

The synthesis of materials from glass-coated ceramic particles, ceramic-glass mixtures or mixtures of ceramic with glass-forming oxides by liquid-phase sintering or viscous sintering is known in industry.

JP-A-11226370 describes the production of hollow fiber membrane modules in which a glass joint is used.

Furthermore, composite glass solders which constitute a mixture of glass solder and ceramic particles are known from the area of joining. The corresponding sintering or joining steps are, however, always associated with shrinkage, so that there are always geometric changes. However, many joining processes cannot be carried out in the event of said geometric changes. Connections to components having established geometry of 3-dimensional connecting elements therefore cannot be produced.

Low-shrinkage glass infiltration methods in ceramic bodies are known from the dental area. However, moldings, such as, for example, inlays or crowns, are produced by infiltration of a porous ceramic body with glass and without joints. The infiltration process is used there because, from the porous, ceramic green compact to the final ceramic-glass composite, only little shrinkage of the molding takes place so that dimensions which are measured on the tooth or obtained by taking an impression can be directly converted into molds for the production of the moldings.

One of these methods from the dental area is the so-called In-Ceram method, as described, for example, in H. Hornberger et al., Microstructures of a high strength alumina glass composite, J. Mater. Res. 11 (1996) [4], pages 855-858. U.S. Pat. No. 4,772,436 describes the production of dental prostheses from porous Al₂O₃ bodies which are infiltrated with glasses which have high contents of La₂O₃, Al₂O₃, SiO₂ and B₂O₃ (from 10 to 40% by weight each) (LASB glasses).

This work from the dental area relates exclusively to the production of isolated moldings. Use as joining or sealing elements is not described. In these methods, initial sintering with little shrinkage is effected prior to the infiltration step in order to consolidate the powder composite mechanically. The process for the production of assemblies by the infiltration method results in little shrinkage compared with sintering but, particularly owing to the initial sintering, is not free of shrinkage. Thus, the shrinkage may be more than 1%. In the abovementioned U.S. Pat. No. 4,772,436, the shrinkage is counteracted by the prior expansion of the plaster mold used. Another counter measure is the addition of Al, which expands on oxidation.

The object of the present invention was to provide methods for the tight and strong sealing of spaces between different components, in particular ceramic moldings. If appropriate, it should be possible to introduce individual passages or a large number of passages. In particular, a gas-tight joint or seal is to be provided. The joining element should be suitable for applications which require high-temperature stability, gas impermeability even at elevated pressure, corrosion resistance, abrasion resistance, chemical resistance and/or good mechanical strength.

The object could surprisingly be achieved with the aid of a ceramic- or metal-glass composite produced by an infiltration method as a joining or sealing element. Surprisingly, the composite could be formed to be substantially free of shrinkage, so that bonding to components which were present in a fixed arrangement was possible. Even complex geometries are directly obtainable. Through the choice of suitable components of the composite, it is possible to obtain joining or sealing elements which exhibit extraordinary stability to high temperatures, chemically aggressive or abrasion-promoting media and corrosion. With the joining or sealing elements, pressure differences of 30 bar can be established at temperatures of 500° C.

Accordingly, the present invention relates to a joining or sealing element made of a glass-infiltrated ceramic or metal composite. The joining or sealing element serves in particular for joining or sealing at least one of the components. The joining or sealing element may be part of an assembly or of an apparatus, the assembly or the apparatus comprising one or more components and at least one joining or sealing element, and the joining or sealing element being connected to at least one of the components. With the joining or sealing elements according to the invention, it is possible to obtain joints or seals which are gas-tight, strong and/or firmly bonded.

The invention is further explained in the drawings, wherein the numbers have the following meanings:

1. Cast, porous section

2. Glass powder, introduced as such or likewise poured in as a suspension

3. Tube of any desired cross-section

4. Gypsum panel

5. Porous green compact or porous layer

6. Glass material as a green compact or layer comprising glass particles or a glass part

7. Plate

8. Rod, tube or electrical conductor

9. Joining or sealing element

10. Feed pipe for nitrogen

11. Discharge

12. Seals

13. Ram for applying a test force

14. Support

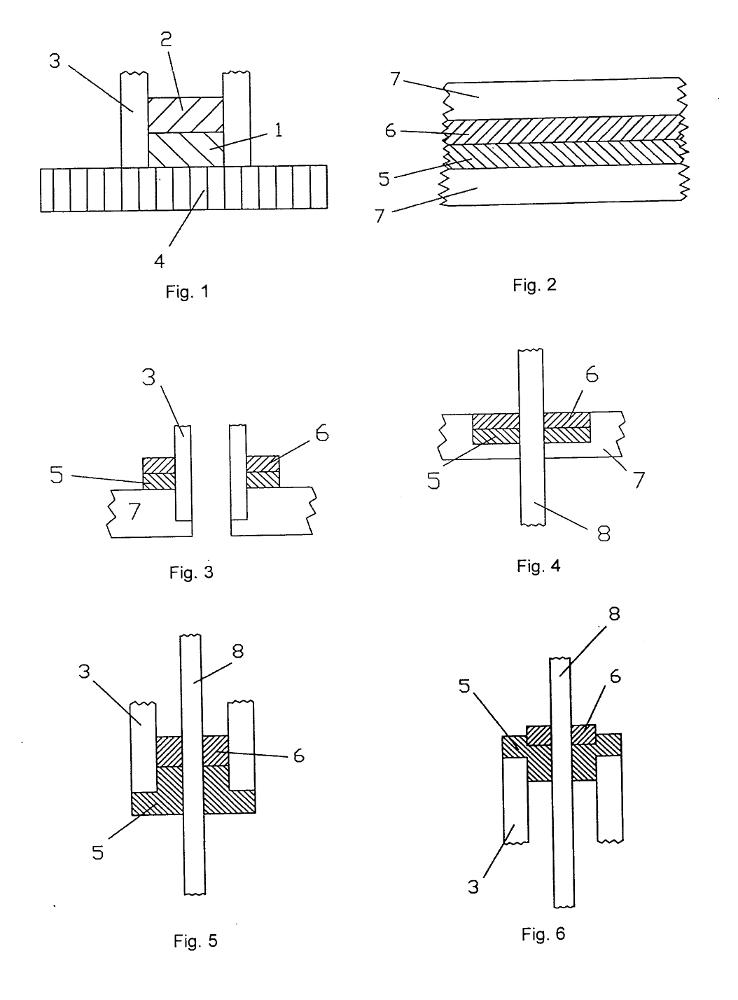

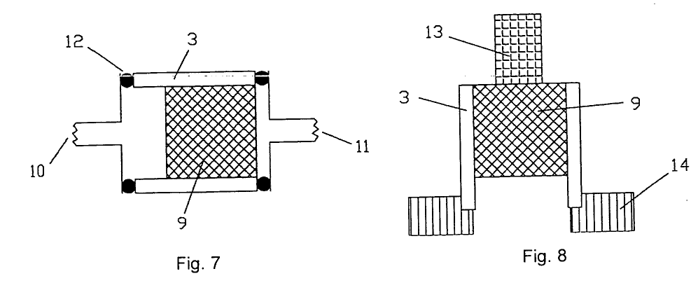

FIG. 1 shows an arrangement prior to infiltration. FIG. 2 shows an arrangement prior to infiltration for joining and sealing sheet-like geometries. FIG. 3-6 show arrangements prior to infiltration with prefabricated ceramic parts. In FIG. 7, the principle of a test arrangement for testing the gas-tightness is explained. In FIG. 8, the principle of a test arrangement for testing the mechanical load-bearing capacity is explained.

The joining or sealing element is connected in particular to at least one component. In general, the component may have any desired geometry. Examples of components are tubes, plates, flanges, cuboids, pipes, rods, profiles or complex components, for example having vaulted, curved, angle-containing or composite geometry. It may preferably be a tube which may also represent the housing. Here, the expressions tube or housing are used interchangeably with one another. It may also be, for example, a tubular opening in a complex body.

The tube or the tubular opening may have any desired cross section, e.g. round, oval, rectangular, square, triangular, hexagonal, T-shaped, star-shaped or irregular, round cross sections being preferred.

In a preferred embodiment, the joining or sealing element also connects to the tube one or more passage elements which are arranged at least partly in the tube and are connected to the joining or sealing element. The passage elements may be, for example, smaller tubes, rods, small rods having small diameters of less than 1 mm, profiles, lamellae or foils. These may likewise have any desired cross sections, for example those mentioned above for the tube. The passage element may be tight or porous. In a preferred embodiment, hollow passage elements are used.

The joining or sealing element can be used for joining, filling or sealing in the case of any desired geometries, a component preferably being a tube or a tubular opening. The joining or sealing element is preferably a joint.

The joining or sealing element, which may also be referred to as connecting element, is preferably a body or a connecting body which may have a shape other than that of sheet-like layers in all three directions. The joining or sealing element may then be regarded as a molding which is connected in particular via at least one surface to at least one component. The shaping is permitted by the method according to the invention, with a result that it is also possible to bridge or connect or seal relatively large spaces.

However, it is also possible to realize joining areas having a thin sheet-like joining or sealing element. For example, two components, e.g. two plates, can be connected to one another via such joining areas. Methods for the production of such joining or sealing elements in the form of layers are explained below.

The joining or sealing element can preferably have a dimension of more than 1 mm or substantially more in a direction perpendicular to the connecting area with the component.

As explained in more detail below, the joining or sealing element is produced in particular with the aid of a casting section. In the preferred embodiment, the joining or sealing element connects, as stated, one or more passage elements which are arranged at least partly in a tube or a tubular opening, the tube or the tubular opening also being connected to the joining or sealing element so that a gas-tight connection results. The passage elements can be led through to the end face of the outer tube or, in the case of an appropriate possibility for fixing during the casting process, can be embedded only over a part of the height of the casting section. On embedding hollow passages, such as tubes, their interiors can be excluded from the filling with the joining or sealing element, so that pipes result. Thus, for example, heat exchangers or, in the case of permeable pipe elements, reactors and filtration elements can be produced. For this purpose, the pipes can be connected via the joining or sealing element according to the invention at more than one position to the outer assembly, e.g. at the ends.

Preferably, gas-tight and strong connections of passage elements with one another and with a housing or tube can be achieved by the invention. The passage elements, preferably small rods or small tubes, used in as large a number as possible, run in the cylindrical housing or tube preferably approximately parallel to the axis thereof and should be incorporated so that a gas-tight joint is obtained. According to the invention, for example, a pressure difference of 30 bar at 500° C. can be realized. The passage elements preferably consist of corundum. The housing or tube then likewise preferably consists of corundum, at least in the region of the joint. These may be small rods or small tubes, which can be tight or porous.

The connection between the passage elements and the housing wall should be present completely in the radial direction and should not be too thin in the axial direction owing to the pressure load. In other words, the joining material should preferably fill the space of complex shape between tube or housing over a certain housing section. This is preferably achieved by means of a casting step.

The components, such as outer tubes, passages and pipes, can preferably be arranged so that the geometries run parallel to the infiltration direction of the glass, since fewer disturbing influences can occur in such geometries. If, for example, a rod is to be incorporated obliquely to the axis of the outer tube, the glass flow is shaded below the rod.

However, experiments have shown that gas-tight joining or sealing elements can be obtained by the method according to the invention, even in the case of geometries having a non-parallel orientation. Thus, in experiments in which about 20 to 40 small corundum rods having a diameter of about 1 mm were placed in a corundum tube having a length of about 50 mm without parallel orientation (disordered, leaning obliquely against the wall of the tube) and were embedded, it was likewise possible to obtain tight samples. Possibly even shaded regions become filled with the glass owing to the capillary effect of the pores.

The method can be adapted to any desired materials to be joined for the component or components, provided that they can be exposed to the infiltration temperature explained below. Of course, this applies only to the regions which are actually exposed to the infiltration temperature. If appropriate, it is conceivable that not the entire component or assembly or the entire apparatus but only a certain part which comprises the joining or sealing element to be produced is exposed to this temperature. For the regions which need not be exposed to the infiltration temperature, any desired customary material may be used.

Regarding the materials to be joined and the temperature used, in particular materials comprising metal and/or ceramic are suitable for the components, including the passage elements. In principle, however, other materials, for example high-melting glasses, are also conceivable. In addition, all materials described below for the connecting elements are suitable for the components.

The joining or sealing element is a ceramic- or metal-glass composite in which the glass is incorporated into the composite by infiltration, a ceramic-glass composite being preferred. The ceramic component used may be any desired conventional ceramic. Examples are silicate ceramics, such as porcelain, steatite, cordierite and mullite, oxide ceramics, such as alumina, magnesium oxide, zirconium oxide, silica, magnesium aluminate spinel, aluminum titanate, lead zirconate titanate and titanium dioxide and non-oxide ceramics, such as borides, silicides, carbides or nitrides, such as silicon carbide, silicon nitride, aluminum nitride, boron carbide and boron nitride. Zirconium oxide and in particular alumina (corundum) are preferably used. Mixed ceramics comprising ZrO₂ and Al₂O₃ are also expedient.

Suitable metal components are all metals which can withstand the infiltration temperature. The metal component also comprises metal alloys. Of course, it is also possible to use mixtures of ceramics or mixtures of metals. In principle, mixtures of metals and ceramics can also be used.

All conventional glass materials can be used as an infiltration glass for the composite. The choice depends in particular on the requirements with regard to the properties expedient in the production of the joining or sealing element, which are explained below. For example, glasses having high contents of La₂O₃, Al₂O₃, SiO₂ and B₂O₃ (from 10 to 40% by weight each) (LASB glasses) can preferably be used, but other conventional glasses are also suitable. For example, it is also possible to use low-melting glasses, preferably phosphate glasses or Tick's glasses, some of which form melts at temperatures below 300° C.

The invention also comprises a method for joining or sealing at least one component with at least one joining or sealing element made of a glass-infiltrated ceramic or metal composite, which comprises
a) arranging or forming a porous material which contains particles of ceramic or metal in the vicinity of or in contact with one or more components which are to be connected to the composite,
b) applying glass material to the porous material,
c) heating the glass material to an infiltration temperature so that the glass is infiltrated into the ceramic or metal material, and
d) cooling with formation of the glass-infiltrated ceramic or metal composite which is connected to at least one component.

After the application of the glass material according to step b), one or more components can be applied to the glass material, if appropriate before the heating according to step c). This is a preferred embodiment in particular in the case of sheet-like joining or sealing elements.

The porous material is in particular a porous green compact or a porous layer, the arrangement or formation of porous green compact being preferred. The porous material can be preformed and then arranged in the vicinity of or in contact with at least one component, or it is formed in the vicinity of or in contact with at least one component. The porous material should of course be placed so close to the component that a connection can be formed. As a rule, the porous material is in contact with the at least one component. If the porous material is formed in situ a powder or a suspension which contain metal or ceramic particles can preferably be used for this purpose.

In a particularly preferred embodiment, porous green compacts are formed by a casting method. The method according to the invention comprises the formation of a porous green compact according to step a) by
a1) pouring of a suspension which contains particles of ceramic or metal into a space so that the component or components which is or are to be connected to the composite is or are brought into contact with the suspension, and
a2) partial or complete removal of the dispersing medium from the suspension of the suspension in order to obtain a green compact.

In step a1) a suspension which contains particles of ceramic or metal is poured into a space so that the component or components which is or are to be connected to the composite is or are brought into contact with the suspension. Examples of suitable ceramic or metal materials are mentioned above. The preferred material is Al₂O₃ or corundum or zirconium dioxide. Any suitable solvent can be used as a dispersing medium for the suspension, for example an organic solvent; usually, it is a suspension in water. Such suspensions, also referred to as slips, are well known in the area of ceramics or of powder metallurgy. The suspensions can, if appropriate, contain conventional additives, such as, for example, antifoams, dispersants, flow improvers and organic binders. The pH of the suspension can be adjusted in a suitable manner by an acid or a base.

The mean particle diameter of the particles which are present in the suspension can be chosen within a wide range. The mean particle diameter may be, for example, more than 0.1 μm. In addition to the choice of the materials used, it is also possible to influence the required temperature of the heat treatment by the choice of a suitable mean particle diameter. According to the present invention, it has surprisingly been found that the use of relatively coarse powder is advantageous. Preferably, the mean particle diameter is greater than 0.4 μm, preferably greater than 1 μm and particularly preferably greater than 8 μm. Expediently, powders having a mean particle diameter of at least 2 μm and preferably at least 5 μm are used, mean particle diameters of at least 8 μm, preferably at least 10 μm and in particular at least 12 μm being particularly suitable.

The mean particle diameter relates here as well as in the subsequent data to the volume average determined, it being possible to use laser diffraction methods (evaluation according to Mie) in the particle size range from 1 to 2000 μm and a UPA (Ultrafine Particle Analyzer, Leeds Northrup (laser-optical)) in the range from 3.5 nm to 3 μm for determining the distributions. In the sectional range from 1 to 3 μm, reference is made here to the measurement by means of UPA.

The space into which the suspension is to be poured can be formed in a conventional manner with inclusion of the component or components. For this purpose additional molds are as a rule required for forming the space, which molds are then removed again. For example, shaped articles comprising gypsum or plastic can be used for this purpose.

The pouring of the suspension into the space can be effected in any customary manner. Preferred methods for shaping are sedimentation methods, such as slip casting, centrifugal casting and centrifugal slip casting, slip casting being particularly preferred. If it is intended to embed numerous passage elements, such as, for example, small rods, it should be ensured that the suspension (subsequently the glass suspension or the glass powder) can be uniformly distributed in between by maintaining appropriate distances between the small rods.

By means of the casting, in particular the centrifugal casting or the slip casting, the suspension is shaped to give a solid cast section. For this purpose, the dispersing medium is partly or completely removed from the suspension in order to obtain a green compact. The removal can be effected, for example, at room temperature or at elevated temperature. As a rule, the dispersing medium is largely or substantially completely removed.

In the case of slip casting, the initial removal of the dispersing medium is usually effected via porous, absorptive plaster molds. The usually still moist green compact obtained is preferably further dried, for example by simply allowing it to stand at room temperature or, if appropriate, elevated temperature, for example over a relatively long period. The production of the green compact by slip casting is well known to the person skilled in the art. A green compact is obtained after the partial or complete removal of the dispersing medium, it being possible to vary the green density. The green compacts suitable have a green density of from about 50 to about 78%, preferably from 60 to 78%.

The pores of the ceramic or metallic green compact should preferably substantially be not closed, i.e. preferably no sintering or initial sintering of the green compact obtained should be effected prior to the glass infiltration. The initial sintering or sintering could lead to closing of the pores. The three-dimensional shrinkage associated with the sintering or initial sintering is counteracted by a connection to a component, such as a housing wall. Instead, according to the invention, the filling of the pore space and hence the sealing take place by the infiltration with a glass. It has been found that the presintering step could be omitted.

The porous material can, however, also be formed by other methods, which are explained below. Where applicable, the above statements also apply to these methods, in particular with regard to usable dispersing media, pores, particle size, green density and preferably omission of presintering.

Thus, for example, it is also possible to use preformed porous materials, in particular porous green compacts, which are arranged with the components. Such three-dimensional green compacts can be produced not only by said casting methods but, for example, also by means of pressing, such as axial or isostatic pressing, injection molding, extrusion and electrophoresis. In methods which require a high proportion of organic process auxiliaries (injection molding, extrusion) it may be necessary to remove the binder in order to obtain an open pore space. The green parts or initially sintered parts can be further processed, for example, by milling, drilling or turning.

In exactly the same way, it is possible to produce not only preformed porous green compacts but also preformed glass parts, for example from glass powder by said methods. Corresponding preformed green compacts and/or glass parts can simply be combined with assemblies and converted by the subsequent infiltration step in elements for joining the assemblies. Pressed ceramic or glass cylinders or ceramic or glass cylinders preformed in another form can be used, for example, for sealing pipes.

For the formation of joining areas with a thin sheet-like joining or sealing element, for example, coating methods or film casting methods can be used. Another possibility is the arrangement of preformed porous layers. Examples of methods for providing the porous layer are the application of a suspension which comprises ceramic or metal particles to a substrate, e.g. a plate, by a customary coating method, such as dipping, spraying, knife-coating or spin coating, or film casting and, if appropriate, subsequent drying or the placing of a ceramic sheet or metallic foil on top.

After the application of the infiltration glass, one or more components, for example a second plate, can be placed on the glass material. After heat treatment for infiltration of the porous layer by the glass and connection, a connection between the components results. Instead of plates any desired assemblies can be connected to one another via flat surfaces or surfaces of complex shapes.

Another possibility for providing the porous material, in particular the porous green compact, is the introduction of powder which comprises metal or ceramic particles. It can be introduced into a space so that the powder is brought into contact with the component or components to be joined or to be sealed. The introduction of the powder can be effected, for example, by trickling in, tapping or shaking in.

In step b), glass material is applied to the green compact. The glass is, for example, likewise introduced as a suspension, as a powder, as a preformed glass part or as a solid glass part. With the use of a suspension, glass material can be poured in, for example in the same way as the suspension which contains the metal or ceramic particles. The production of glass parts has already been explained. Solid glass parts may be obtained, for example, simply by melting in a suitable mold.

The glass material is expediently chosen so that it has a thermal expansion adapted to the ceramic used or the metal used. Furthermore, it is expedient to choose a glass which has a viscosity curve and a stability to crystallization which permit the sufficient depth of infiltration at the permissible heat treatment temperature. The transformation temperature should of course be greater than the temperature of use.

The person skilled in the art can choose the glass with the suitable properties depending on the materials used. For example, LASB glasses are suitable. It is also possible to use conventional glasses, for example those which, in comparison with LASB glasses, have lower SiO₂ contents and smaller amounts of Al₂O₃ or no Al₂O₃. However, all glass compositions are suitable provided that they have the suitable properties. It is well known to the person skilled in the art and there is relevant detailed literature, for example O. V. Mazurin, M. V. Streltsina, T. P. Shvaiko-Shvaikovskaya “Handbook of glass data”, Elsevier-Verlag or various publications by A. A. Appen.

Heating to an infiltration temperature so that the glass is infiltrated into the ceramic or metal material is subsequently effected in step c). The infiltration temperature does of course depend on the materials used and may vary within wide ranges. Preferably, relatively low infiltration temperatures are chosen. The infiltration temperature is preferably not more than 1200° C., preferably not more than 1150° C. LASB glasses are suitable, for example, for infiltration temperatures of about 1100° C., and other commercial glasses can be infiltrated, for example, at from 980 to 1000° C. However, it is also possible to use low-melting glasses, preferably phosphate glasses or Tick's glasses, some of which form melts at temperatures below 300° C.

After infiltration is complete, cooling is effected with formation of the glass-infiltrated ceramic or metal composite which is connected to at least one of the components. It was surprnsingly found that the joining or sealing element can be obtained virtually free of shrinkage by the method according to the invention and that the freedom from shrinkage is of major importance for realizing a tight and strong connection between joining or sealing element and component.

Listed below are some properties and parameters which it may be expedient or advantageous to observe in the case of the present invention. In the preferred procedure, one or more conditions, preferably as many as possible, are fulfilled.

With regard to the material (ceramic and/or metal particles) for the porous material, in particular the porous green compact:
1. The material should preferably be subjected to no intrinsic sintering-related shrinkage at the infiltration temperature. Depending on the infiltration temperature, this can expediently be established by suitable choice of the minimum size for the particle size. For example, corundum AA-18 (“Advanced Alumina” from Sumitomo Chemicals, Japan, mean particle size: 22.8 μm) can be infiltrated at 1100° C. without harmful shrinkage effects, whereas corundum AA-2 (mean particle size: 2.1 μm) shrinks by itself on infiltration at 1100° C. At an infiltration temperature of 1000° C., there is substantial freedom from shrinkage even with corundum AA-2.
2. The particle size distribution of the material to be infiltrated determines the pore size of the porous body or of the porous layer and hence the infiltration rate.
3. The material to be infiltrated can be formed or preformed in any desired manner, shaping by slip casting being preferred. The green density after drying should be sufficiently high that, on infiltration, the material does not shrink due to particle re-orientation.
4. All ceramics, metals and materials which withstand the infiltration temperature and the attack of the glass melt can be used for producing the porous material.

With regard to the glass:
1. On the basis of the experiments carried out in combination with calculations by means of the Washburn equation (relationship between t_{inf}, viscosity, pore size, depth of penetration and further material properties), an expedient viscosity of the glass at the infiltration temperature is in the range from 10² to 10⁴ dPa·s for pore sizes in the μm range for infiltration times in the region of a few hours.
2. The glass should be chosen so that no components are evaporated off at the infiltration temperature, substantially no crystallization takes place during infiltration and good wetting of the material to be infiltrated results.
3. The glass preferably contains a component which corresponds to the ceramic used, and is preferably virtually saturated with this component (e.g. Al₂O₃ content of the glass on infiltration of corundum). The concentration of this component in the glass may correspond, for example, to at least 80% of the saturation content in the glass.

Functioning connections can be produced with regard to gas-tightnesses and mechanical load-bearing capacity even with glasses which do not fulfill this condition (e.g. the glasses V5 and V7 in the examples for corundum). However, optimum results are obtained if this condition is fulfilled (e.g. the glass INF-LA in the examples for corundum) since defects in the composite structure (flow channels, large pores) can be minimized with the use of these glasses. In the case of the first-mentioned glasses, these defects are probably due at least partly to the fact that, for example in the case of a corundum ceramic, Al₂O₃ is dissolved from the ceramic in the glass. If larger volume fractions of the corundum particles are lost through dissolution shrinkage due to particle re-orientation may occur.
4. The glass transition temperature should be above the intended subsequent temperature of use and the glass should expediently be corrosion-resistant.
5. The glass should be adapted to the parts to be joined and the material to be infiltrated with regard to the thermal expansion behavior.

In the case of the infiltration method according to the invention, a material which can be characterized as ceramic-glass composite or metal-glass composite forms. Depending on the method of shaping the ceramic or metallic porous body and the efficiency of the particle packing, the structure contains from, for example, 40 or 50 to 80% by volume, preferably from 60 to 80% by volume, of crystallites. In particular, packings with from 65 to 74% by volume of crystallites are obtained, it being possible to reduce the lower limit by “poorer” shaping. The remaining space in the structure consists of the glass phase and possibly of phases which are formed by crystallization from the glass phase or melt phase, and pores.

After the glass infiltration, the volume fraction of the crystallites of the infiltrated material corresponds approximately to the prior green density. During the infiltration, preferably no sintering processes occur or said processes occur only to a relatively insignificant extent, i.e. the ceramic or metal particles used can preferably be substantially unsintered and present at the same size distribution as in the starting material even in the final ceramic composite or metal composite.

Since shrinkage leads to detachment of the connecting element to be produced from the component so that a tight joint is not obtained, the substantial freedom from shrinkage which is permitted by the present method is particularly advantageous. The shrinkage is minimized in particular by using relatively coarse ceramic or metal particles and/or relatively low infiltration temperatures. In particular, mean particle diameters in the suspension of more than 8 μm are preferred.

A further advantage of the use of relatively coarse powder is the achievement of higher depths of infiltration by the glass. Preferably, the depth of infiltration is more than 1 or 2 mm and more preferably more than 6 mm. According to the invention, depths of infiltration of up to 10 mm or more can therefore be achieved, whereas the infiltration up to a depth of 5 mm is achieved according to the prior art. Infiltration depths about 2 to 3 times greater in comparison with the prior art could be achieved by the choice of relatively coarse ceramic particles, which is advantageous for the mechanical stability of the joining or sealing element.

The materials of the components and of the joining or sealing element should expediently be tailored to one another, in particular with regard to the thermal expansion behavior. If possible, the use of identical materials is expedient. Thus, Al₂O₃ is suitable as material to be infiltrated, in order to realize adaptation of thermal expansion to housings and small rods or small tubes comprising corundum.

Advantageously, the composite is adapted to the component or components with regard to the thermal expansion. In the case of components of approximately identical thermal expansion which are to be joined or to be sealed, joining or sealing elements having the same or a similar thermal expansion should generally be used. If it is intended to join or to seal components having different thermal expansion, thermal expansion of the joining or sealing element would be adjusted to a mean value in order to compensate the differences stepwise and thus to minimize the mechanical stresses. This task of joining or sealing components of different thermal expansion and the adaptation described for realization are frequently used in industry.

According to the invention, a joining or sealing element is obtained by the combination of the steps comprising placing of a porous material, preferably by pouring a suspension into a space and removing the dispersing medium, and infiltration of the porous material with a glass. The glass performs the function of filling the pore space and of binding to the parts to be joined. Shrinkage processes can be minimized and can be compensated by binding of glass so that mechanically strong and gas-tight connections are obtained. Embedded parts, such as, for example, a relatively large number of small rods, can also be incorporated in the desired manner.

The joining or sealing element serves for joining or sealing components. The joining or sealing element is preferably part of an assembly or of an apparatus, at least one component of the assembly or of the apparatus being connected to the joining or sealing element. These may be, for example, infiltration apparatus, reactors or heat exchangers or parts thereof.

For example, in a preferred embodiment, the joining or sealing elements according to the invention can be used in filtration apparatuses for filtration in the area of biotechnology, medical technology or microsystem/measurement technology. In another preferred embodiment, the joining or sealing elements can be used in reactors or in assemblies containing electrical conductors.

FIG. 1 shows an arrangement prior to infiltration. The ceramic green compact 1 was obtained by a prior casting process. The glass section 2 was likewise introduced by casting a suspension or as powder. FIG. 2 shows an arrangement prior to infiltration for joining and sealing sheet-like geometries. For the porous ceramic and glass layers (5, 6) all shaping methods can be used for producing layers.

FIG. 3-6 show arrangements prior to infiltration with prefabricated ceramic particles 5, these being porous green compacts which are obtained by pressing or other shaping methods, and with prefabricated glass parts 6 which are produced in the same way as the ceramic parts or as a solid glass part. The parts to be joined and the parts which form the joining or sealing element on infiltration can be arranged, for example, as shown.

FIG. 7 shows the principle of a test arrangement for testing the gas tightness. FIG. 8 shows the principle of the test arrangement for testing the mechanical load-bearing capacity.

With the joining or sealing elements, substantial pressure differences can be built up at temperatures to below the transformation temperature of the infiltration glass (e.g. 600° C.) with no gas permeation occurring. For example, the sealing element in a tube having an internal diameter of 16 mm could be loaded with a pressure of 32 bar at room temperature and at 500° C. (cf. examples 1-3). According to the test arrangement in FIG. 7, this corresponds to a force of 0.64 kN acting through the gas on the sealing element. With a mechanical test according to FIG. 9, it was possible to load such sealing elements by means of a ram having a diameter of 12 mm to at least 5 kN. This demonstrates the outstanding quality of the mechanical connection of the joining or sealing element to the at least one assembly connected thereto.

Examples for explaining the invention follow.

### EXAMPLES

a) Corundum Suspension

An aqueous suspension of coarse corundum particles “AA-18” (“Advanced Alumina” from Sumitomo Chemicals, Japan; mean particle size: 22.8 μm) having a solids content of 81% by weight with HNO₃ having a pH of from 3 to 4 is prepared with stirring. Octanol (1 drop per 100 g of powder) is added as an antifoam. The suspension is stirred until pouring.

b) Glasses (All Compositions in % By Weight)

Infiltration glass INF-LA

| SiO₂ | Al₂O₃ | CaO | B₂O₃ | Na₂O | La₂O₃ | TiO₂ | Fe₂O₃ |
|---|---|---|---|---|---|---|---|
| 18.6 | 17.7 | 2.7 | 14.8 | 3.0 | 37.8 | 3.9 | 1.5 |

Infiltration glass V5 (Schoft glass no. G018-222, proportions according to manufacturer's data):

| B₂O₃ | La₂O₃ | Gd₂O₃ | SiO₂ | ZnO | ZrO₂ | Nb₂O₅ | Ta₂O₅ | Sb₂O₃ | BaO |
|---|---|---|---|---|---|---|---|---|---|
| 10-50 | 10-50 | 10-50 | 1-10 | 1-10 | 1-10 | 1-10 | 1-10 | <1 | <1 |

This glass was used in the examples only with d₅₀≧3 μm owing to the tendency to crystallize.

Infilatration glass V7 (Schoft glass no. G018-221, proportions according to manufacturer's data):

| B₂O₃ | La₂O₃ | SiO₂ | ZnO | ZrO₂ | CaO | TiO₂ | SrO | Sb₂O₃ |
|---|---|---|---|---|---|---|---|---|
| 10-50 | 10-50 | 1-10 | 1-10 | 1-10 | 1-10 | 1-10 | 1-10 | <1 |

### Example 1

A corundum tube (Øₑₓₜ=20 mm, wall thickness from 2 to 2.5 mm, height 35 mm) is placed with its end face on a plaster panel which consists of molding plaster customary for slip casting. 2 ml of the above suspension are introduced into the corundum tube by means of a pipette. After drying for one day, the tube with the corundum poured in is removed from the panel, and 0.6 ml of INF-LA glass powder (complete glass volume, not bulk volume) is introduced. There follows a heat treatment: RT −10 K/min→1100° C./6 h −5 K/min→RT, the glass infiltrating into the corundum section.

The tube can be sawn about 2 millimeters above the joint section. The ends are ground smooth and plane-parallel so that pressure can be applied according to FIG. 7. The sample withstands the loading by nitrogen at a pressure of 32 bar at RT and up to 500° C. and is tight to gas permeation. This also applies after prior aging of the sample several times at 500° C. The sample withstands mechanical loads of at least 5 kN according to FIG. 8 without fracture.

### Examples 2 and 3

Example 1 is repeated, but with the following glasses and heat treatments:

V5: RT −1.0 K/min→1000° C./6 h −5 K/min→RT

V7: RT −10 K/min→980° C./6 h −5 K/min RT

The same sample properties (gas tightness and mechanical load-bearing capacity) as in example 1 result.

### Examples 4 to 6

Before casting, a plurality of small corundum rods are inserted into the tube. In the case of a small rod diameter of about 1 mm, for example, 50 pieces can be incorporated. They can be placed on the plaster panel (if a sufficient diameter permits stability), may rest obliquely against the tube wall or may be aligned and fixed by means of suitable aids parallel to the tube axis or as desired. Two minutes after casting of the suspension according to examples 1 to 3 any aids used for alignment and fixing of the small rods are removed since the corundum green compact then performs this function. All further steps as in examples 1 to 3 follow, and the same sample properties are obtained.

### Example 7

The sample was produced as in example 3, but corundum tubes having Øₑₓₜ=35 mm were used and 10 ml of corundum suspension and 3 ml of V7 glass as powder were added. Heat treatment for infiltration, RT −10 K/min→990° C./6 h −5 K/min→RT. The sample is then gas-tight, tested at room temperature and with 12 bar gas pressure.

### Example 8

The sample was produced as in example 1, but a corundum U-profile was placed in the tube before casting of the Al₂O₃ suspension. After the heat treatment, composite, tube and U-profile are firmly connected to one another according to visual evaluation.

### Example 9

Two corundum tubes (external diameter and wall thickness of the outer tube: 50 mm, 3 mm; external diameter and wall thickness of the inner tube: 30 mm, 2 mm) are placed one inside the other on a plaster panel. The inner tube need not be centered. Only a minimum distance of, for example, 1 mm should be maintained between the walls of the two tubes so that this suspension can penetrate into the space between the two walls. 8mi of the suspension are introduced between the two tubes. As a result of the rapid withdrawal of water by the plaster panel, no suspension runs into the interior of the inner tube. After drying, 2.4 ml of INF-LA glass are introduced onto the green compact. Infiltration takes place according to example 1. Thereafter the tubes and the joining or sealing element are firmly connected to one another according to visual evaluation. The inner tube is open and thus forms a pipe.

1.-39. (canceled)

40. A joining or sealing element comprising at least one of a glass-infiltrated ceramic composite and a glass-infiltrated metal composite.

41. The joining or sealing element of claim 40, wherein the element is connected to at least one component.

42. The joining or sealing element of claim 41, wherein a connection between the element and the at least one component is gas-tight.

43. The joining or sealing element of claim 41, wherein a thermal expansion of the element corresponds to a thermal expansion of the at least one component.

44. The joining or sealing element of claim 40, wherein the element joins or seals at least a first component having a first thermal expansion and a second component having a second thermal expansion which is different from the first thermal expansion, the element having a thermal expansion which is between the first thermal expansion and the second thermal expansion.

45. The joining or sealing element of claim 40, wherein the element comprises a glass-infiltrated ceramic composite.

46. The joining or sealing element of claim 40, wherein the joining or sealing element comprises a joint.

47. The joining or sealing element of claim 40, wherein the at least one of a glass-infiltrated ceramic composite and a glass-infiltrated metal composite comprises particles of at least one of a metal and a ceramic which have an average particle diameter of greater than 0.4 μm.

48. The joining or sealing element of claim 47, wherein the particles have an average particle diameter of greater than 1 μm.

49. The joining or sealing element of claim 47, wherein the particles have an average particle diameter of greater than 8 μm.

50. The joining or sealing element of claim 47, wherein a glass infiltration depth of the at least one of a glass-infiltrated ceramic composite and a glass-infiltrated metal composite is more than 1 mm.

51. The joining or sealing element of claim 48, wherein a glass infiltration depth of the at least one of a glass-infiltrated ceramic composite and a glass-infiltrated metal composite is more than 6 mm.

52. The joining or sealing element of claim 40, wherein a proportion of at least one of a metal and a ceramic in the at least one of a glass-infiltrated ceramic composite and a glass-infiltrated metal composite is from 40% to 80% by volume.

53. The joining or sealing element of claim 48, wherein a proportion of at least one of a metal and a ceramic in the at least one of a glass-infiltrated ceramic composite and a glass-infiltrated metal composite is from 60% to 80% by volume.

54. The joining or sealing element of claim 41, wherein the at least one component comprises at least one of a tube, a plate, a flange, a cuboid, a rod, a profile and a component of complex shape.

55. The joining or sealing element of claim 41, wherein the at least one component comprises a tube.

56. The joining or sealing element of claim 55, wherein one or more additional components are connected to the joining or sealing element and comprise one or more passage elements which are arranged at least partially inside the tube.

57. The joining or sealing element of claim 56, wherein the one or more passage elements comprise at least one of a small tube, a tube, a small rod, a rod, a profile, a lamella and a film.

58. The joining or sealing element of claim 56, wherein the one or more passage elements comprise a hollow element which is not closed by the joining or sealing element, resulting in a pipe.

59. The joining or sealing element of claim 40, wherein the element is present as at least one of a layer and a three-dimensional body.

60. An assembly or apparatus which comprises the joining or sealing element of claim 40.

61. The assembly or apparatus of claim 60, wherein the assembly or apparatus comprises at least one component which is connected to the joining or sealing element.

62. A heat exchanger which comprises the joining or sealing element of claim 40.

63. A filtration apparatus which comprises the joining or sealing element of claim 40.

64. A method for joining or sealing at least one component with a joining or sealing element which comprises at least one of a glass-infiltrated ceramic composite and a glass-infiltrated metal composite, which method comprises
(a) at least one of arranging and forming a porous material which comprises particles of at least one of a ceramic and a metal in a vicinity of or in contact with one or more components which are to be connected to the glass-infiltrated composite,
(b) applying a glass material to the porous material,
(c) heating the glass material to a temperature at which the glass material infiltrates the porous material, and
(d) cooling the glass-infiltrated porous material to form the glass-infiltrated composite which is connected to the at least one component.

65. The method of claim 64, wherein after (b) and before (c) one or more further components are arranged on the glass material.

66. The method of claim 64, wherein the porous material comprises at least one of a porous green compact and a porous layer.

67. The method of claim 66, wherein the porous green compact is formed by
(a1) pouring a suspension comprising particles of at least one of a ceramic and a metal into a space adjacent to one or more components to bring the suspension into contact with the one or more components, and
(a2) partially or completely removing a dispersing medium from the suspension to form a porous green compact.

68. The method of claim 66, wherein the at least one of a porous green compact and a porous layer is formed from a suspension comprising particles of at least one of a ceramic and a metal by centrifugal casting or slip casting.

69. The method of claim 64, wherein in (a) at least one of a preformed porous green compact and a preformed porous layer is used.

70. The method of claim 69, wherein the porous green compact is produced by a dry pressing process.

71. The method of claim 64, wherein the porous material is formed by introducing a powder comprising particles of at least one of a ceramic and a metal into a space adjacent to one or more components to bring the powder into contact with the one or more components.

72. The method of claim 71, wherein the powder is introduced by at least one of trickling, tapping and shaking.

73. The method of claim 64, wherein a porous layer of at least one of metal particles and ceramic particles is formed on the at least one component by a coating method or a film casting method.

74. The method of claim 64, wherein a porous layer of at least one of metal particles and ceramic particles is formed by arranging a porous film comprising the at least one of metal particles and ceramic particles on the at least one component.

75. The method of claim 64, wherein the glass material is applied as at least one of a glass powder, a preformed glass part and a suspension.

76. The method of claim 64, wherein the porous material is produced by using a powder or suspension comprising particles of at least one of a ceramic and a metal having an average particle diameter of greater than 0.4 μm.

77. The method of claim 76, wherein the average particle diameter is greater than 1 μm.

78. The method of claim 76, wherein the average particle diameter is greater than 8 μm.

79. The method of claim 64, wherein the heating temperature of (c) is not higher than 1200° C.

80. The method of claim 79, wherein the temperature is not higher than 1150° C.

81. The method as of claim 64, wherein at the temperature of (c) the porous material does not shrink as a result of sintering.

82. The method of claim 64, wherein at the heating temperature of (c) the glass has a viscosity of from 10² to 10⁴ dPa·s.

83. The method of claim 64, wherein in (c) and (d) substantially no crystallization of the glass takes place.

84. The method of claim 64, wherein the glass contains a component which corresponds to the ceramic, and the concentration of the component in the glass is at least 80% of a saturation concentration of the component in the glass.

85. A method of joining or sealing one or more components in an assembly or apparatus, wherein the method comprises using the joining or sealing element of claim 40.

86. The method of claim 85, wherein the assembly or apparatus comprises a filtration apparatus or a reactor for liquid or gaseous media, except in a hollow-fiber membrane module, for the filtration of liquids in the pharmaceutical industry, textile industry, food and beverage industry, metal processing/machining, printing industry, for drinking water/waste water, processed water, in reactor technology, the paper industry and chemical industry and, except in a hollow-fiber membrane module, for the separation and reaction of gas mixtures in the chemical industry, energy technology, catalyst technology and petrochemistry.

87. The method of claim 84, wherein the one or more components comprise an electrical conductor.
